(19) United States
(12) Patent Application Publication
(10) Pub. No.: US 2010/0054825 A1
(43) Pub. Date: Mar. 4, 2010

(54) IMAGE FORMING APPARATUS

(75) Inventors: Jeong Yong Ju, Hwaseong-si (KR); Gi Cheol Jeong, Suwon-si (KR); Jun Ho Lee, Seoul (KR); Byeong Hwa Ahn, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/545,162

(22) Filed: Aug. 21, 2009

(30) Foreign Application Priority Data
Sep. 1, 2008 (KR) 2008-85715

(51) Int. Cl. G03G 15/01; G03G 21/00

(52) U.S. Cl. 399/302; 399/358

(57) ABSTRACT

An image forming apparatus includes a transfer unit to transfer a toner to a printing medium, and a waste toner recovery unit to convey a waste toner recovered from the transfer unit. A first driving source for driving the transfer unit is configured independently of a second driving source for driving the waste toner recovery unit, so that deterioration in the quality of image caused by the waste toner recovery unit can be minimized.

### CROSS-REFERENCE TO RELATED APPLICATIONS

This application claims priority under 35 U.S.C. §119(a) from Korean Patent Application No. 10-2008-85715 filed on Sep. 1, 2008, in the Korean Intellectual Property Office, the disclosure of which is incorporated herein by reference in its entirety.

### BACKGROUND

1. Field of the Invention

The present general inventive concept relates to an image forming apparatus. More particularly, the present general inventive concept relates to an image forming apparatus having a waste toner recovery unit for recovering a waste toner.

2. Description of the Related Art

In general, an image forming apparatus refers to an apparatus that forms an image on a printing medium such as paper according to an input image signal, and includes a printer, a copier, a facsimile, and a multifunction peripheral that combines such functions.

The image forming apparatus forms the image on the printing medium by using an exposure unit that irradiates light having image information within a body forming an external appearance of the image forming apparatus, a development unit that develops a visible image through the light irradiated from the exposure unit, a transfer unit that transfers the visible image developed by the development unit to a printing medium, a fixture unit that fixes the visible image to the printing medium by applying heat and pressure to the printing medium, and a paper discharge unit that discharges the printing medium on which the visible image is formed to the outside of the body.

Recently, an image forming apparatus equipped with a waste toner recovery unit has been developed to recover a waste toner from the development unit or the transfer unit in the process of forming the image.

### SUMMARY

The present general inventive concept provides an image forming apparatus, which properly selects a driving source for a waste toner recovery unit, thereby minimizing a bad influence on a quality of an image caused by the waste toner recovery unit.

Additional features and utilities of the general inventive concept will be set forth in part in the description which follows and, in part, will be apparent from the description, or may be learned by practice of the general inventive concept.

Exemplary embodiments present general inventive concept can be achieved by providing an image forming apparatus including a transfer unit driven by a first driving source and to transfer a toner to a printing medium, and a waste toner recovery unit driven by a second driving source independently of the first driving source and to convey a recovered waste toner.

The image forming apparatus may further include a fixture unit to fix the toner transferred to the printing medium on the printing medium, and to be driven by the second driving source.

The image forming apparatus may further include a paper discharge unit to discharge the printing medium on which an image is formed to an outside of the image forming apparatus, and to be driven by the second driving source.

The transfer unit may include an intermediate transfer member to transfer the toner to the printing medium, and the first driving source may include the transfer motor to rotate the intermediate transfer member.

The transfer unit may include the intermediate transfer member comprising an intermediate transfer belt shaped as a belt, and a plurality of intermediate transfer belt rollers to rotate the intermediate transfer belt, and the transfer motor may be connected to one of the intermediate transfer belt rollers so as to transmit a rotating force.

The waste toner recovery unit may include at least one waste toner conveyer member driven by a rotating force transmitted from the second driving source.

The at least one waste toner conveyer member may include a feed screw rotated by the second driving source, and a conveyor belt to convey the waste toner fed by the feed screw.

The waste toner recovery unit may receive a rotating force from the second driving source through a plurality of recovery gears.

The image forming apparatus may further include a clutch unit installed between the second driving source and the waste toner recovery unit to selectively transmit a rotating force of the second driving source to the waste toner recovery unit.

The image forming apparatus may further include a paper return unit to return the printing medium P to the transfer unit.

Exemplary embodiments of the present general inventive concept may also be achieved by providing an image forming apparatus including a transfer unit driven by a first driving source to transfer a visible image developed through a toner to a printing medium, a fixture unit driven by a second driving source independently of the first driving source to fix the toner developed on the printing medium to the printing medium, and a waste toner recovery unit to convey a waste toner recovered from the transfer unit using a rotating force transmitted from the second driving source.

Exemplary embodiments of the present general inventive concept may also be achieved by providing an image forming apparatus including an image carrier to transfer a toner image to a printing medium, a fixture unit to fix the toner image transferred to the printing medium, and a waste toner recovery unit to recover a waste toner remaining on the image carrier using a rotating force transmitted from a driving source driving the fixture unit.

### BRIEF DESCRIPTION OF THE DRAWINGS

These and/or other features and utilities of the present general inventive concept will become apparent and more readily appreciated from the following description of certain exemplary embodiments, taken in conjunction with the accompanying drawings of which:

FIG. 1 is a cross-sectional view illustrating an image forming apparatus according to an exemplary embodiment of the present general inventive concept;

FIG. 2 is a perspective view illustrating a transfer unit and a waste toner recovery unit according to an exemplary embodiment of the present general inventive concept;

FIG. 3 is a perspective view illustrating a power transmission path between a fixture motor and a waste toner recovery unit according to an exemplary embodiment of the present general inventive concept; and

FIG. 4 is a perspective view illustrating a development unit according to an exemplary embodiment of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements. The exemplary embodiments are described below to explain the present general inventive concept by referring to the figures.

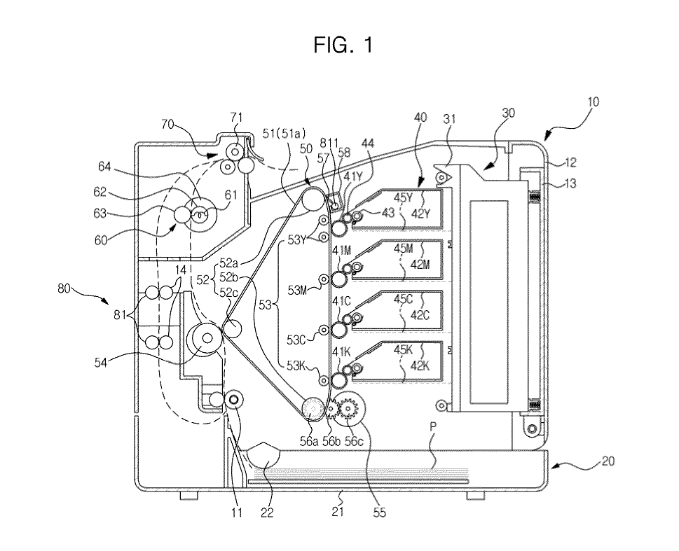

As illustrated in FIG. 1, the image forming apparatus according to an exemplary embodiment of the present general inventive concept includes various units in a body 10 forming an external geometry, and particularly a paper feed unit 20 that feeds a printing medium P such as paper, an exposure unit 30 that scans light having image information, a development unit 40 that develops a visible image through the light scanned by the exposure unit 30, a transfer unit 50 that transfers the visible image developed by the development unit 40 to the printing medium P, a fixture unit 60 that fixes the visible image to the printing medium P by applying heat and pressure to the printing medium P, a paper discharge unit 70 that discharges the printing medium on which the image is formed to the outside of the body 10, and a paper return unit 80 that can return the printing medium P such that both sides of the printing medium P are printed. The operations of the paper feed unit 20, the exposure unit 30, the development unit 40, and transfer unit 50, the fixture unit 60, the paper discharge unit 70, and the paper return unit 80 are directed by a controller (not shown).

The paper feed unit 20 includes a tray 21 on which the printing media P are loaded, and a pickup roller 22 that picks up the printing media P loaded on the tray 21 one by one. The printing medium P picked up by the pickup roller 22 is fed to the transfer unit 50 by a feed roller 11 installed in the body 10.

The exposure unit 30 scans light generated from a scanning optical system (not shown) installed therein onto photoconductors 41 of the development unit 40 before the printing medium P enters the transfer unit 50. The body 10 is provided with an external cover 12 on one side thereof so as to be able to draw out, exchange and repair a variety of parts in the body 10, and an internal cover 13 inside the external cover 12 disposed such that the exposure unit 30 is installed therein. Further, the exposure unit 30 is provided with a shutter 31 that closes a window for light (not shown) when the external cover 12 is open.

Thus, as a user opens the external cover 12, the exposure unit 30 installed on the internal cover 13 is drawn to the outside of the body 10, and thus the development unit 40 installed inside the exposure unit 30 can be drawn to the outside of the body 10. Further, when the external cover 12 is open, the light window of the exposure unit 30 is closed by the shutter 31. As such, in the state in which the external cover 12 is open, and thus the exposure unit 30 is drawn to the outside of the body 10, the light generated from the exposure unit 30 does not leak out.

In an exemplary embodiment, the photoconductors 41Y, 41M, 41C and 41K are configured as image carriers holding a toner image so as to correspond to developers 42Y, 42M, 42C and 42K, respectively disposed in parallel in a longitudinal direction, and each has a latent image formed on the surface thereof by the corresponding light 45Y, 45M, 45C and 45K scanned from the exposure unit 30.

The development unit 40 includes the developers 42Y, 42M, 42C and 42K in which toners of yellow, magenta, cyan and black are contained, respectively. In an exemplary embodiment, the image forming apparatus is a tandem type in which the developers 42Y, 42M, 42C and 42K are arranged in parallel in a longitudinal direction, and the photoconductors 41Y, 41M, 41C and 41K are provided so as to correspond to the developers 42Y, 42M, 42C and 42K. Each of the developers 42Y, 42M, 42C and 42K includes a delivery roller 43 and a development roller 44, and thus delivers the toner to the corresponding photoconductors 41Y, 41M, 41C and 41K. However, this is not intended as a limitation thereto, and the developers 42Y, 42M, 42C and 42K can be arranged in any configuration permitting them to deliver toner to the photoconductors 41Y, 41M, 41C and 41K.

The fixture unit 60 includes a heat roller 62 in which a heater 61 is mounted, a pressure roller 63 pressing the printing medium P toward the heat roller 62, and a fixture motor 64 generating a rotating force to transmit the rotating force to at least one of the heat roller 62 and the pressure roller 63. The printing medium P, to which the image is transferred by the toner while passing through the transfer unit 50, is fed to the fixture unit 60, and thus passes between the heat roller 62 and the pressure roller 63 of the fixture unit 60. At this time, heat and pressure are applied to the printing medium P, so that the toner transferred to the printing medium P is fixed to the printing medium P.

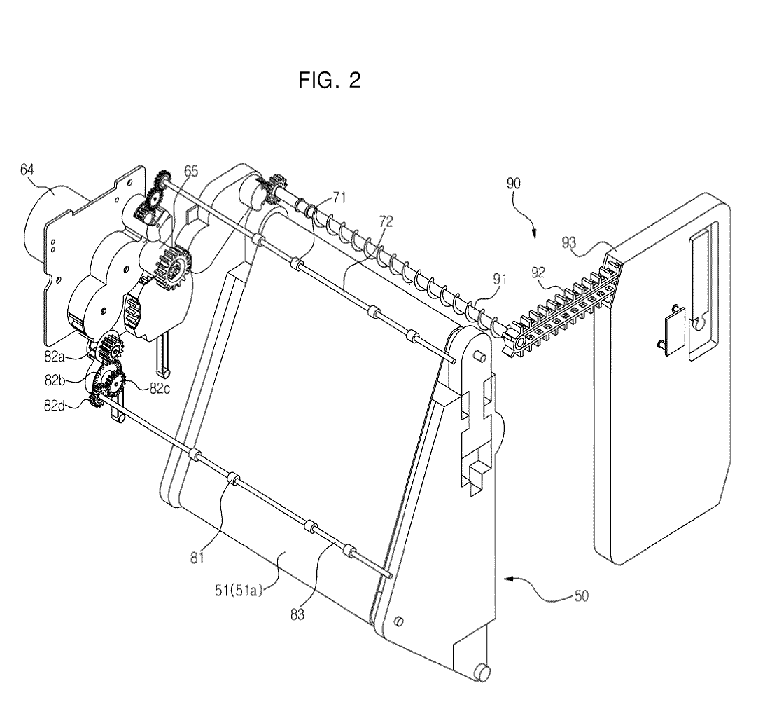

The paper discharge unit 70 includes at least one paper discharge roller 71 to allow the printing medium P to be discharged to the outside of the body 10 by rotation, and a paper discharge shaft 72 (illustrated in FIG. 2) to transmit a rotating force to the paper discharge roller 71. The printing medium P passing through the fixture unit 60 is discharged to the outside of the body 10 past the paper discharge roller 71. In an exemplary embodiment, the paper discharge roller 71 is rotated by the rotating force transmitted from the fixture motor 64 through a plurality of paper discharge gears, further described below, so as to discharge the printing medium P.

The paper return unit 80 returns the printing medium P, on one side of which an image is formed, to the transfer unit 50 such that and image is formed on both sides of the printing medium P, and includes a pair of return rollers 81 that returns the printing medium P to the transfer unit 50 again. In an exemplary embodiment, the return rollers 81 are rotated by the rotating force transmitted from the fixture motor 64, a second driving source, through a plurality of return gears 82a, 82b, 82c and 82d and a return shaft 83 (see FIG. 2), thereby returning the printing medium P.

Meanwhile, the pair of return rollers 81 are disposed in the body 10 together with idle rollers 14 corresponding to the respective return rollers 81 such that the printing medium P is returned to the transfer unit 50 through a gap between the return rollers 81 and the idle rollers 14. The fixture motor 64 is adapted to generate a rotating force in one direction or in the other direction so as to reversely rotate the paper discharge roller 71 to guide the printing medium P to the paper return unit 80.

The transfer unit 50 is repetitively delivered with a visible image of each of the photoconductors 41Y, 41M, 41C and 41K, and then transfers the delivered images to the printing medium P. In detail, the latent image is formed on the surface of each of the photoconductors 41Y, 41M, 41C and 41K by the exposure unit 30, and then toner is delivered to the photoconductors 41Y, 41M, 41C and 41K, so that a visible image is developed by the toner. The visible image developed on each of the photoconductors 41Y, 41M, 41C and 41K is repetitively transferred to an intermediate transfer member 51 that rotates in contact with the photoconductors 41Y, 41M, 41C and 41K, so that a color image is formed. The intermediate transfer member 51 is configured as an image carrier in which the toner image is contained. In an exemplary embodiment, the intermediate transfer member 51 is implemented as an intermediate transfer belt 51a, however this is not intended as a limitation thereto. For example, the intermediate transfer member 51 may also be implemented as a drum or as a plurality of drums to receive the visible image formed on the photoconductors 41Y, 41M, 41C and 41K. The intermediate transfer belt 51a on which the color image is formed transfers the image to the printing medium P such that the image is formed on the printing medium P by the aid of the toner. The intermediate transfer belt 51a is rotatably connected with a transfer motor 55 via intermediate transfer belt rollers 52. The intermediate transfer belt 51a transfers the image while predetermined tension is applied by the intermediate transfer belt rollers 52 and transfer rollers 53 and 54.

The intermediate transfer belt rollers 52 are in contact with the intermediate transfer belt 51a such that tension is applied to the intermediate transfer belt 51a. The intermediate transfer belt rollers 52 are classified as first, second and third intermediate transfer belt rollers 52a, 52b and 52c. The first, second and third intermediate transfer belt rollers 52a, 52b and 52c are in contact with an inner circumference of the intermediate transfer belt 51a such that the intermediate transfer belt 51a maintains a tightly pulled state, i.e. a tensioned state. In an exemplary embodiment, the transfer motor 55 is connected with the intermediate transfer belt roller 52c through a plurality of transfer gears 56a, 56b and 56c. Thus, a rotating force generated from the transfer motor 55 is transmitted to the intermediate transfer belt roller 52c through the transfer gears 56a, 56b and 56c such that the intermediate transfer belt 51a rotates around the first, second and third intermediate transfer belt rollers 52a, 52b and 52c. In this process, the image formed on the photoconductors 41Y, 41M, 41C and 41K is transferred. However, this is not intended as a limitation thereto, and a rotating force may also be supplied to the intermediate transfer belt rollers 52a and/or 52b in other exemplary embodiments.

The transfer rollers 53 and 54 are classified as first transfer rollers 53Y, 53M, 53C and 53K pressing the intermediate transfer belt 51a toward the photoconductors 41Y, 41M, 41C and 41K, and a second transfer roller 54 engaged with the third intermediate transfer belt roller 52c with the intermediate transfer belt 51a in between. The first transfer rollers 53Y, 53M, 53C and 53K press the intermediate transfer belt 51a toward the photoconductors 41Y, 41M, 41C and 41K such that the visible images formed on the photoconductors 41Y, 41M, 41C and 41K are transferred to the intermediate transfer belt 51a. The second transfer roller 54 presses the intermediate transfer belt 51a toward the third intermediate transfer belt roller 52c such that the images repetitively formed on the intermediate transfer belt 51a are transferred to the printing medium P as the printing medium P passes between the second transfer roller 54 and the intermediate transfer belt 51a.

Further, the transfer unit 50 includes a cleaning blade 57 to separate a waste toner remaining on the intermediate transfer belt 51a, and a waste toner collector 58 to collect the waste toner separated by the cleaning blade 57. Thus, after the transferring of the toner to the printing medium P is completed, the waste toner remaining on the intermediate transfer belt 51a can be separated by the cleaning blade 57, and thus can be collected into the waste toner collector 58.

Further, as illustrated in FIG. 2, the image forming apparatus is equipped with a waste toner recovery unit 90, which can recover the waste toner separated from the intermediate transfer belt 51a after the transferring of the toner to the printing medium P is completed at the transfer unit 50. The waste toner recovery unit 90 can include at least one or two waste toner conveyor members 91 and 92, and a waste toner recovery container 93 containing the waste toner conveyed by the waste toner conveyor members 91 and 92. In an exemplary embodiment, the waste toner conveyor members 91 and 92 includes a feed screw 91, which is rotatably installed on the waste toner collector 58 and can convey the waste toner separated from the intermediate transfer belt 51a toward one widthwise side of the intermediate transfer belt 51a, and a conveyor belt 92, which can convey the waste toner handed over through the feed screw 91 to the waste toner recovery container 93. In an exemplary embodiment, the conveyor belt 92 can be installed on one end of the feed screw 91. Thus, the conveyor belt 92 can rotate around the feed screw 91 by rotation of the feed screw 91, and can convey the waste toner.

The waste toner recovery unit 90 can be adapted to be operated by a rotating force transmitted from a second driving source independently of the transfer motor 55 serving as the first driving source for driving the intermediate transfer belt 51a.

This configuration of this exemplary embodiment is directed to improving a quality of image formed on the printing medium P. If the waste toner recovery unit 90 is configured to receive the rotating force from the transfer unit 50, a rotating speed of the transfer motor 55 may be reduced by load increase that may occur at the waste toner recovery unit 90. A rotating speed of the intermediate transfer belt 51a may thereby be reduced, so that the image quality may be degraded. To prevent this phenomenon, the waste toner recovery unit 90 is adapted to be operated by the second driving source.

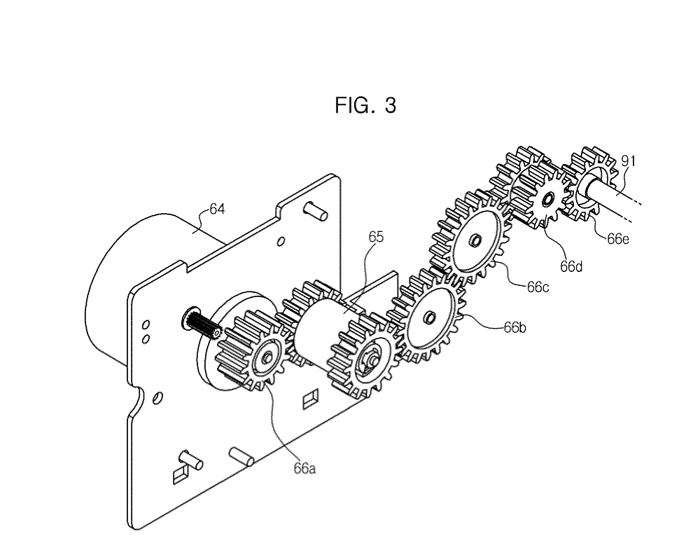

In an exemplary embodiment, the second driving source is configured as the fixture motor 64 independently of the transfer motor 55 which can serve as the first driving source. As illustrated in FIGS. 2 and 3, the waste toner recovery unit 90 can be connected to the fixture motor 64 through a plurality of recovery gears 66a, 66b, 66c, 66d and 66e so as to be operated by the rotating force transmitted from the fixture motor 64. In this manner, when the waste toner recovery unit 90 is configured to receive the rotating force from the fixture motor 64, the load applied to the fixture motor 64 is increased by the waste toner recovery unit 90, and thus the rotating speed of the fixture motor 64 is reduced. As a result, a time for which the printing medium P passes between the heat roller 62 and the pressure roller 63 is increased. However, even in this case, the quality of image formed on the printing medium P is hardly degraded due to the increased time.

Further, according to the exemplary embodiment as described above, the image forming apparatus is a duplex type in which the image can be formed on both sides of the printing medium P. Thus, the fixture motor 64 in an exemplary embodiment is adapted to be able to generate the rotating force in one direction or in the other direction. In the case in which the fixture motor 64 reversely rotates for double-side printing, the feed screw 91 reversely rotates to be able to convey the waste toner in a direction opposite a direction where the waste toner is to be conveyed.

Accordingly, in an exemplary embodiment a clutch unit 65 is installed between the recovery gears 66a, 66b, 66c, 66d and 66e connecting the feed screw 91 and the fixture motor 64 with each other, and thus selectively transmits the rotating force of the fixture motor 64 to the waste toner recovery unit 90 depending on the rotating direction of the fixture motor 64. More specifically, in the case in which the fixture motor 64 is driven to rotate the paper discharge roller 71 in one direction in order to discharge the printing medium P on which printing has been completed, the clutch unit 65 causes the rotating force of the fixture motor 64 to be transmitted to the waste toner recovery unit 90. Further, in the case in which the fixture motor 64 is driven to rotate the paper discharge roller 71 in the other direction in order to print both sides of the printing medium P, the clutch unit 65 prevents the rotating force of the fixture motor 64 from being transmitted to the waste toner recovery unit 90.

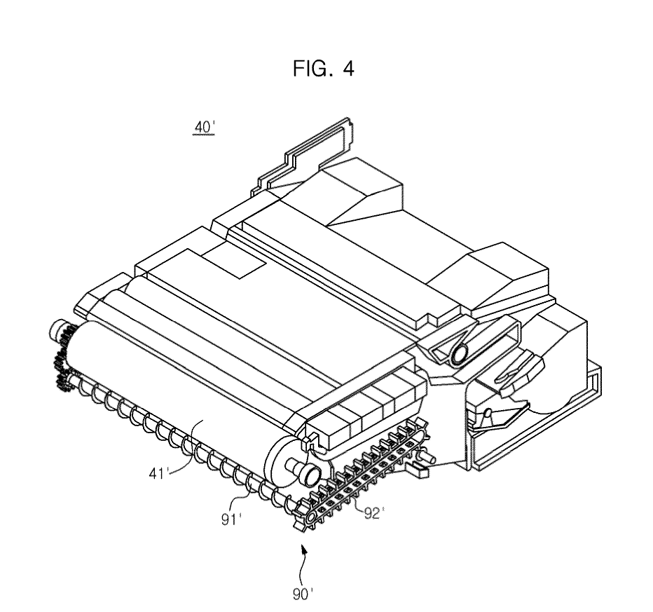

In an exemplary embodiment, the waste toner recovery unit 90 is adapted to recover the waste toner generated from the transfer unit 50 using the feed screw 91 and the conveyor belt 92. However, the exemplary embodiments are is not limited to this configuration. For example, as illustrated in FIG. 4, the waste toner recovery unit 90′ may be adapted to recover the waste toner generated from the development unit 40′. In detail, a feed screw 91′ and a conveyor belt 92′ are installed on the development unit 40′ such that the feed screw 91′ conveys the waste toner generated from the photoconductors 41′ of the development unit 40′ toward one axial side of each photoconductor, and such that the conveyor belt 92′ conveys the waste toner from the feed screw 91′ to a separate storage space (not shown) again. Thereby, the waste toner recovery unit 90′ can recover the waste toner generated from the photoconductors 41′ of the development unit 40′.

In an exemplary embodiment, the paper discharge unit 70 is adapted to be rotated by the rotating force transmitted from the fixture motor 64. However, the exemplary embodiments are not limited to this configuration. For example, in the case in which the paper discharge unit 70 includes a separate paper discharge motor (not shown) for rotating the paper discharge roller 71, the second driving source can be configured as the paper discharge motor. Thereby, the waste toner recovery unit 90 can be rotated by a rotating force transmitted from the paper discharge motor.

In an exemplary embodiment, since the image forming apparatus includes the intermediate transfer belt 51a, the waste toner recovery unit 90 is adapted to recover the waste toner from the intermediate transfer belt 51a. However, in the case of the image forming apparatus in which the toner images are adapted to be directly transferred from the photoconductors to the printing medium, the waste toner recovery unit 90 can be configured to convey the toner recovered from the photoconductors, and then the waste toner recovery unit 90 can be operated by the driving source such as the fixture motor 64, the paper discharge motor, or the like, which is independent on the driving source for rotating the photoconductors 41.

In an exemplary embodiment, the image forming apparatus uses the intermediate transfer belt 51a as the intermediate transfer member 51. However, the exemplary embodiments are not limited to this configuration. For example, a drum-like intermediate transfer member may be used as the intermediate transfer member.

In an exemplary embodiment, the image forming apparatus that is configured to deliver the toner from the numerous developers 42Y, 42M, 42C and 42K to the numerous photoconductors 41Y, 41M, 41C and 41K, and then transfer the toner delivered to the numerous photoconductors 41Y, 41M, 41C and 41K to the printing medium P through the intermediate transfer member 51 has been described by way of an example. However, the exemplary embodiments are not limited to this configuration. For example, the general inventive concept may be equally applied to an image forming apparatus that is configured to deliver the toner from the numerous developers 42Y, 42M, 42C and 42K to a single photoconductor, and then directly transfer the toner from the single photoconductor to the printing medium P.

Although few exemplary embodiments of the present general inventive concept have been illustrated and described, it will be appreciated by those skilled in the art that changes may be made in these exemplary embodiments without departing from the principles and spirit of the general inventive concept, the scope of which is defined in the claims and their equivalents.

What is claimed is:

1. An image forming apparatus comprising:
a transfer unit driven by a first driving source to transfer a toner to a printing medium; and
a waste toner recovery unit driven by a second driving source independently of the first driving source to convey a recovered waste toner.

2. The image forming apparatus of claim 1, further comprising:
a fixture unit to fix the toner transferred to the printing medium on the printing medium, and to be driven by the second driving source.

3. The image forming apparatus of claim 1, further comprising:
a paper discharge unit to discharge the printing medium on which an image is formed to an outside of the image forming apparatus, and to be driven by the second driving source.

4. The image forming apparatus of claim 1, wherein the transfer unit includes an intermediate transfer member to transfer the toner to the printing medium, and the first driving source includes a transfer motor to rotate the intermediate transfer member.

5. The image forming apparatus of claim 4, wherein the intermediate transfer member comprises an intermediate transfer belt shaped as a belt, and a plurality of intermediate transfer belt rollers to rotate the intermediate transfer belt, and the transfer motor is connected to one of the intermediate transfer belt rollers to transmit a rotating force.

6. The image forming apparatus of claim 1, wherein the waste toner recovery unit includes at least one waste toner conveyer member driven by a rotating force transmitted from the second driving source.

7. The image forming apparatus of claim 6, wherein the at least one waste toner conveyer member includes a feed screw rotated by the second driving source, and a conveyor belt to convey the waste toner fed by the feed screw.

8. The image forming apparatus of claim 1, wherein the waste toner recovery unit receives a rotating force from the second driving source through a plurality of recovery gears.

9. The image forming apparatus of claim 1, further comprising:
a clutch unit installed between the second driving source and the waste toner recovery unit to selectively transmit a rotating force of the second driving source to the waste toner recovery unit.

10. The image forming apparatus of claim 1, further comprising:
a paper return unit to return the printing medium to the transfer unit.

11. An image forming apparatus comprising:
a transfer unit driven by a first driving source and to transfer a visible image developed through a toner to a printing medium;
a fixture unit driven by a second driving source independently of the first driving source to fix the toner developed on the printing medium to the printing medium; and
a waste toner recovery unit to convey a waste toner recovered from the transfer unit using a rotating force transmitted from the second driving source.

12. The image forming apparatus of claim 11, wherein the second driving source includes a fixture motor to drive the fixture unit.

13. The image forming apparatus of claim 12, further comprising:
a clutch unit installed between the fixture motor and the waste toner recovery unit to selectively transmit the rotating force of the fixture motor to the waste toner recovery unit.

14. The image forming apparatus of claim 11, further comprising:
a paper return unit to return the printing medium to the transfer unit, wherein the paper return unit is driven by the rotating force transmitted from the second driving source.

15. An image forming apparatus comprising:
an image carrier to transfer a toner image to a printing medium;
a fixture unit to fix the toner image transferred from the image carrier to the printing medium and driven by a driving source; and
a waste toner recovery unit to recover a waste toner remaining on the image carrier using a rotating force transmitted from the driving source driving the fixture unit.

16. The image forming apparatus of claim 15, wherein the image carrier includes at least one photoconductor to transfer the toner image, and an intermediate transfer member containing the toner image transferred from the photoconductor, and wherein the intermediate transfer member is driven by a second driving source independently of the driving source to drive the waste toner recovery unit.

17. The image forming apparatus of claim 15, further comprising:
a clutch unit, which is installed between the fixture unit and the waste toner recovery unit to selectively transmit power of the driving source driving the fixing unit to the waste toner recovery unit.

18. The image forming apparatus of claim 15, further comprising:
at least one return roller to guide the printing medium to the image carrier, wherein the return roller is driven by the rotating force transmitted from the driving source driving the fixture unit.
